(19) United States
(12) Patent Application Publication
(10) Pub. No.: US 2007/0198408 A1
(43) Pub. Date: Aug. 23, 2007

(54) Methods to facilitate cash payments

(76) Inventor: Frederick William Beer, Bloomfield Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/362,404

(22) Filed: Feb. 21, 2006

(51) Int. Cl. G06Q 40/00

(52) U.S. Cl. 705/41

(57) ABSTRACT

Methods to facilitate cash payments are provided. The methods use a tangible medium that includes information about a seller, a buyer, and a financial institution that will accept the buyer's cash payment. A party other than the buyer has a deposit account at the financial institution that will accept the buyer's cash payment.

### BACKGROUND OF THE INVENTION

1. Field of the Invention

This invention relates to methods to facilitate cash payments.

2. Background Art

Sellers offering products or services over media such as TV, radio, telephone, or internet are usually limited in the forms of payment they can accept. For example, a seller lacking a physical presence in a particular area may be unable to accept a cash payment from a potential buyer in that area. Such sellers thus do not have the ability to service potential buyers preferring or needing to pay cash.

Attempts to address various issues in this general area include the following references:

The patent to Josephson 4,974,878 provides for a financial data processing system using payment coupons. Josephson discloses a payment coupon disposed with machine readable information in the form of MICR. The machine readable data may typically consist of a payment amount and a payor's account number with the payee. Optional settlement by various payment methods include automated teller machine and manned teller workstation.

The patent to Mersky et al. 6,119,106 provides for a method and apparatus for facilitating customer payments to creditors from a remote site. Mersky et al. discuss a customer visiting an agent site and tendering payment, where customer information on a creditor billing statement, such as account number, creditor name, customer name and address, is entered into an agent system via a scanner. When the total calculated amount is paid, a receipt including a table with columns of creditor name, customer account number, and amount paid is provided to the customer.

The patent application publication to Hoyos et al. 2002/0037097 A1 provides for a coupon recognition system. Hoyos et al. discuss a paper bill or coupon scanned and compared to a database of coupons to determine the coupon type and associated vendor. Additionally, an associated customer account identifier, account balance, and related account data may be determined from the coupon. A symbol type that may be identified includes MICR.

The patent application publication to Ellis 2002/0095374 A1, provides for a method and apparatus for processing cash payments for electronic and internet transactions. Ellis discusses a point-of-presence provided for receiving cash deposits for transactions such as suspended orders awaiting payment for execution. In another embodiment, an activation code is printed on the receipt when a transaction is successfully completed.

The patent to Hilt et al. 5,465,206 provides for an electronic bill pay system. Hilt et al. disclose a biller being assigned a unique identifier, a biller reference number (BRN). A bill is sent from biller B to consumer C with indication of B's BRN, amount due, and consumer C's C-B account number. A bill pay order may be passed from consumer C to bank C by hand. Bank C may then transfer payments due to bank B.

The patent application publication to Song et al. 2004/0139014 A1, provides for an anti-fraud remote cash transaction system. Song et al. disclose a remote payment center where payer may enter a payee name and identification information, dollar amount, and other information after opening an account with RPC. RPC system may then issue a fund secured transaction identification number (FSTIN), which the payer may pass on to payee, who may then request the payment of any RPC.

### SUMMARY OF THE INVENTION

An aspect of the invention provides a method to facilitate a cash payment between a seller and a buyer. The method includes receiving data identifying a seller, a buyer, and a financial institution that will accept the cash payment. The method also includes processing the data identifying the seller, the buyer, and the financial institution to generate information about the cash payment. The information includes the identity of the seller, the buyer, and the financial institution. The method further includes fixing the information in a tangible medium.

The tangible medium may be in a physical format.

A magnetic medium may embody the information.

A device capable of generating a radio frequency may embody the information.

Indicia may embody the information.

The indicia may appear in an MICR format.

The indicia may be electronically readable.

The indica may be optically scanable.

The indicia may include data identifying a product or service.

The data may identify a product and a product identification number.

The data may identify a service and a service identification number.

The tangible medium may be in an electronic format.

The data identifying the seller may include a financial institution associated with the seller.

Another aspect of the invention provides a method to facilitate a cash payment between a seller and a buyer. The method includes receiving information from a tangible medium. The information identifies a seller, a buyer, and a financial institution that will accept the cash payment. The method also includes processing the information to generate data about the cash payment. The data include the identity of the seller, the buyer, and the financial institution. The method further includes transmitting a signal that contains the data about the cash payment.

The tangible medium may be in a physical format.

A magnetic medium may embody the information.

A device capable of generating a radio frequency may embody the information.

Indicia may embody the information.

The indicia may appear in an MICR format.

The indicia may be electronically readable.

The indica may be optically scanable.

The indicia may include data identifying a product or service.

The data may identify a product and a product identification number.

The data may identify a service and a service identification number.

The tangible medium may be in an electronic format.

The data identifying the seller may include a financial institution associated with the seller.

Yet another aspect of the invention provides a method to facilitate a cash payment between a seller and a buyer. The method includes receiving a signal. The signal contains data derived from information fixed in a tangible medium. The information identifies a seller, a buyer, and a financial institution that accepted the cash payment. The method also includes processing the data from the signal and initiating a transfer of a monetary value from a deposit account based on the data contained in the signal.

The tangible medium may be in a physical format.

A magnetic medium may embody the information.

A device capable of generating a radio frequency may embody the information.

Indicia may embody the information.

The indicia may appear in an MICR format.

The indicia may be electronically readable.

The indica may be optically scanable.

The indicia may include data identifying a product or service.

The data may identify a product and a product identification number.

The data may identify a service and a service identification number.

The tangible medium may be in an electronic format.

The data identifying the seller may include a financial institution associated with the seller.

The above aspects and other aspects, features, and advantages of the present invention are readily apparent from the following detailed description of the preferred embodiment(s) for carrying out the invention when taken in connection with the accompanying drawings.

### BRIEF DESCRIPTION OF THE DRAWINGS

FIG. 1 is a block diagram of an embodiment of the invention;

FIG. 2 is another block diagram of the embodiment of FIG. 1;

FIGS. 3a and 3b are a flow chart of an embodiment of the invention; and

FIG. 4 is a list of information that a seller can provide in order to register with a third party facilitator in accordance with the embodiment of FIGS. 3a and 3b.

### DETAILED DESCRIPTION OF THE PREFERRED EMBODIMENT(S)

The invention generally relates to methods that, for example, enable sellers to accept cash payments from buyers in areas where sellers may lack a physical presence.

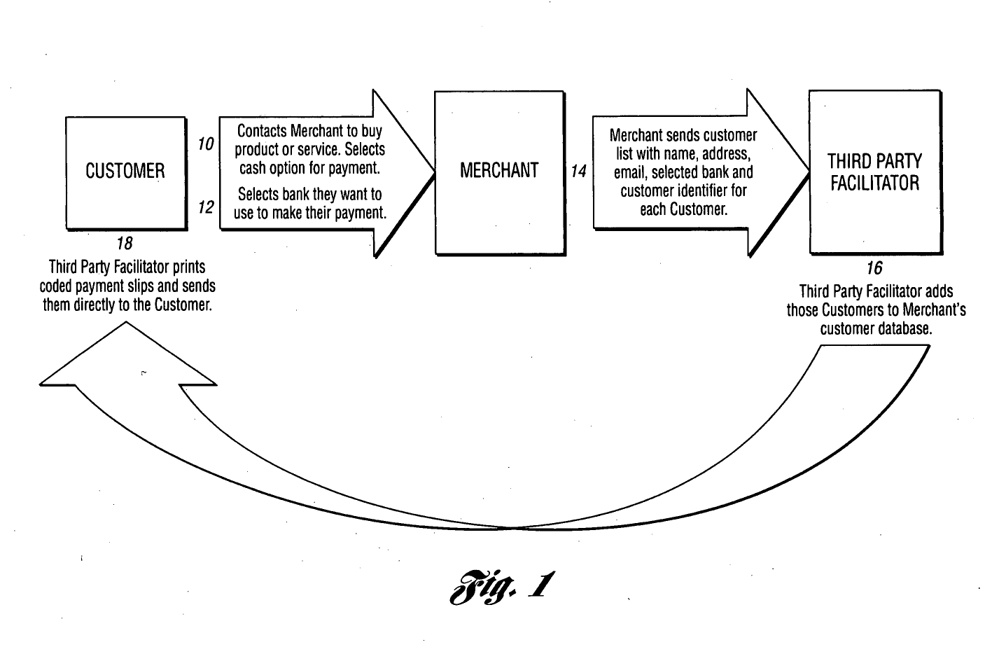

Referring to FIG. 1, a customer contacts, such as via the internet, a merchant who has preregistered with a third party facilitator to buy a product or service and selects cash as the method of payment 10. The customer then selects the bank they want to use to make their cash payment 12.

The merchant collects certain identifying information from the customer such as name, address, and email and assigns the customer an account number and payment due date. The merchant uploads the collected data to a secure website maintained by the third party facilitator 14.

The third party facilitator receives the collected data regarding the transaction and adds it to a database where such information regarding the merchant resides 16. The third party facilitator then processes this data and generates an identification number, or ID, that links the data identifying the customer making the cash payment and the merchant who is to receive the payment. The third party facilitator prints payment slips using the MICR specification associated with the particular bank selected by the customer and sends the payment slips to the customer 18. The MICR line of the payment slip includes the bank's routing number as well as the ID.

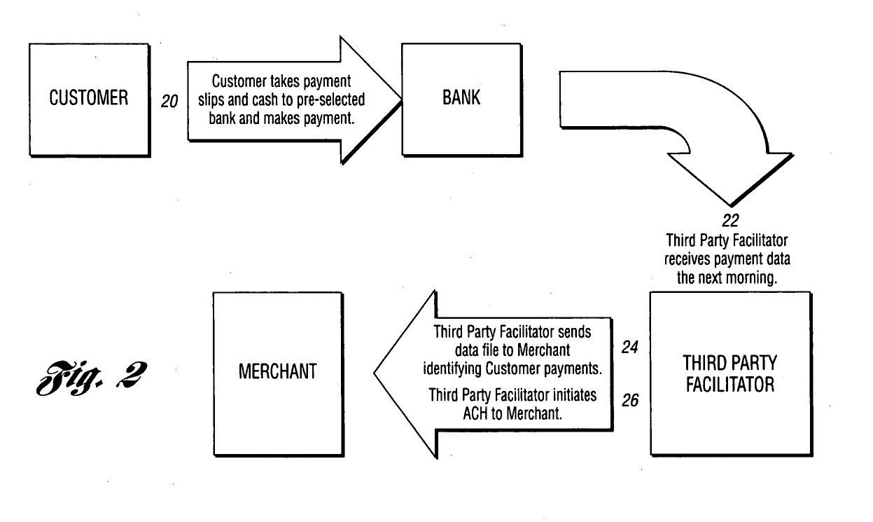

Referring to FIG. 2, the customer takes their payment slips and cash to the branch of the bank selected to receive their payment 20. The bank reads and processes the information contained in the MICR line. The bank then transmits the information read from the payment slip as well as other payment information to the third party facilitator.

The third party facilitator receives and processes the information 22. The third party facilitator sends a data file to the merchant identifying the customer payment 24. The data file thus informs the merchant about the cash payment. The third party facilitator initiates an automated clearing house transaction to the merchant 26.

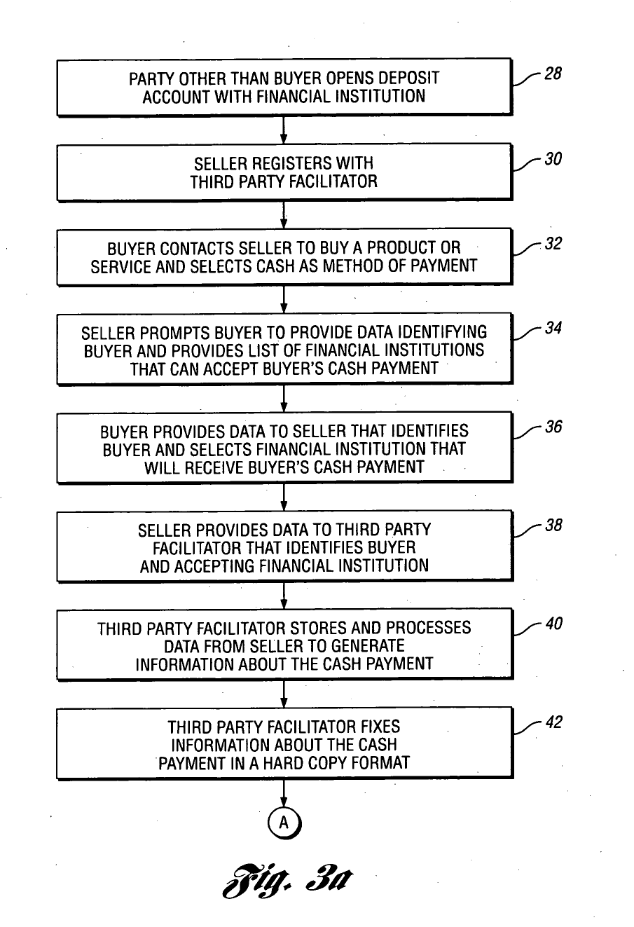

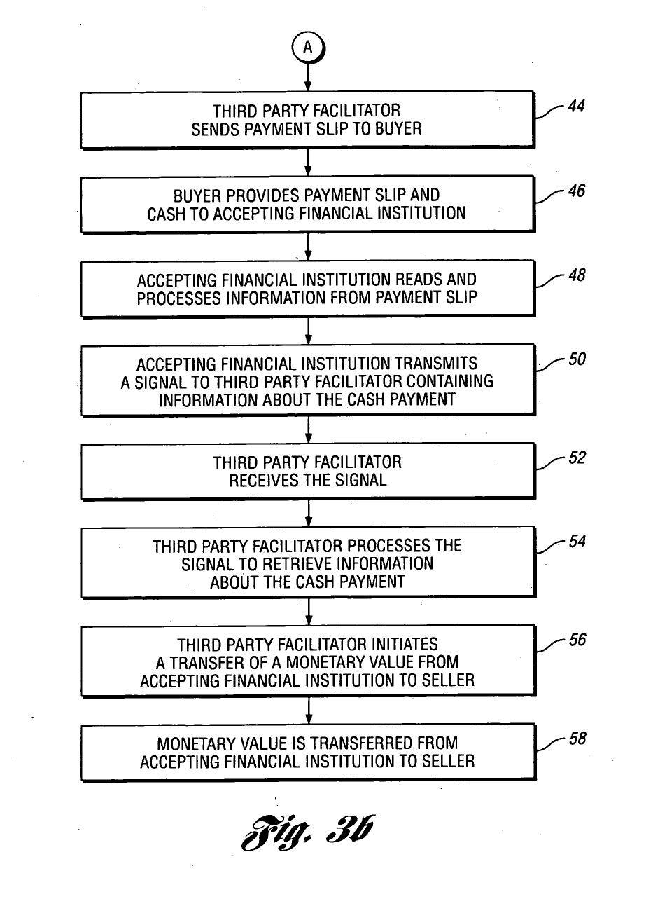

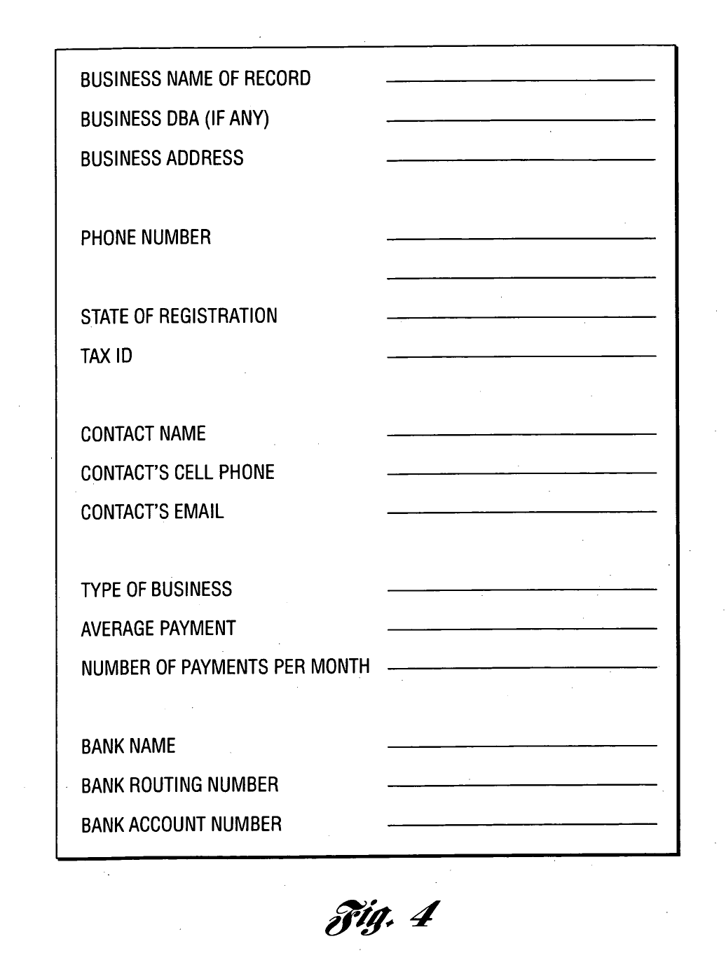

Referring to FIG. 3a, a party other than a buyer, for example a third party facilitator, i.e., a third party that will facilitate a cash payment between a seller and buyer, or a seller, opens a deposit account with at least one financial institution in at least one geographic location 28. The cash payment will be deposited in the deposit account. A seller registers with the third party facilitator 30. To register, the seller provides certain identifying information, such as the information shown in FIG. 4, to the third party facilitator.

A buyer contacts the seller to buy a product or service and selects cash as the method of payment 32. The seller prompts the buyer to provide data identifying the buyer and provides a list of financial institutions in the buyer's geographic region that can accept the buyer's cash payment 34. The buyer need not have an account at the financial institution selected because these financial institutions maintain the deposit accounts explained at 28. The buyer provides data to the seller that identifies the buyer, such as the buyer's name and address, and selects a financial institution that will receive the buyer's cash payment, i.e., the accepting financial institution, 36.

The seller provides the data to the third party facilitator that identifies the buyer and the accepting financial institution 38. The third party facilitator stores the data received from the seller in a database and processes the data from the seller to generate information about the cash payment 40. This information includes data identifying the buyer, seller, and accepting financial institution. The data identifying the buyer, seller, and accepting financial institution could take the form of an identification number, or ID, generated by the third party facilitator. The ID could include characters that are unique to each buyer. The ID could also include characters that are unique to each tangible medium explained below. The ID links the data identifying the buyer, seller, and accepting financial institution. By referencing the ID, the third party facilitator can thus recall the data provided by the seller at 38 from a database where such data resides. The third party facilitator fixes the information in a hard copy format by printing out a payment slip 42.

The information about the cash payment may be fixed in any tangible medium. For example, the information may be fixed in a physical format such as a payment card or payment slips. A magnetic medium, such as a magnetic strip, may embody the information about the cash payment. A device capable of generating a radio frequency, such as a radio frequency identification chip, may also embody the information about the cash payment. Indica or other markings, such as bar coding or MICR, may embody the information about the cash payment. Such indica or markings may be electronically readable or optically scanable. Additionally, advertising or a product identification number (PIN) could be included thus allowing a buyer to purchase services, e.g., prepaid cell phone minutes. The PIN could be activated once the seller has received the payment.

The information about the cash payment may be fixed in an electronic format and transmitted, for example, to a buyer's cell phone or computing device, such as a home computer or mobile computing device. The buyer may choose to print out the information about the cash payment. The buyer may alternatively choose to transmit the information about the cash payment to the accepting financial institution before or at the same time of making the cash payment. The information about the cash payment may also be transmitted, for example, to a party that will subsequently fix the information in a physical format, such as a payment card or payment slip, and deliver the payment card or payment slip to the buyer.

Referring to FIG. 3b, the third party facilitator sends the payment slip to the buyer 44. The buyer provides the payment slip and cash to the accepting financial institution 46. The accepting financial institution deposits the cash in the deposit account explained at 28. Thus, buyers can make cash payments at financial institutions where they lack an account. The accepting financial institution reads and processes the information from the payment slip 48, and transmits a signal to the third party facilitator 50. The signal contains information about the cash payment including information read from the payment slip.

Under circumstances where a third party facilitator has deposit accounts at several financial institutions, these financial institutions may, for example, transmit their respective signals to the third party facilitator or to a financial institution associated with the third party facilitator. If the financial institutions maintaining the third party facilitator's deposit accounts transmit their respective signals to a financial institution associated with the third party facilitator, the financial institution associated with the third party facilitator can aggregate the information received and transmit a signal containing the aggregated information to the third party facilitator. The same holds true for circumstances where a merchant has deposit accounts at several financial institutions.

The third party facilitator receives the signal 52, and processes it to retrieve information about the cash payment 54. The third party facilitator can thus, for example, (1) check that the information about the cash payment matches the information from the payment slip, (2) track the number of payment slips, if any, remaining with the buyer, and (3) tabulate payments and any third party facilitator fees for the seller.

The third party facilitator initiates a transfer of a monetary value from the accepting financial institution to the seller, or a financial institution associated with the seller, based on the information about the cash payment 56. For example, the third party facilitator could initiate an automated clearing house (ACH) transaction from the accepting financial institution to the seller. The monetary value is transferred from the accepting financial institution to the seller 58.

Referring to FIG. 4, examples of the types of information a seller can provide in order to register with a third party facilitator, as discussed at 30 with respect to FIG. 3a, are listed. A particular third party facilitator, however, may require less or more information.

The invention offers a number of advantages to sellers including:

VoIP resellers, ISPs, pre-paid phone resellers and distributors, as well as website sellers can offer a cash payment option to buyers;

Pre-paid resellers and distributors can expand outside of their current geographic locations and accept cash from customers in locations where the resellers and distributors lack a physical presence;

Sellers can service all of the buyers that their marketing programs have attracted, including those customers that want or need to pay cash; and

Sellers can have buyers pre-pay for services thus avoiding bad debt.

The invention also offers a number of advantages to buyers including:

Buyers that do not have a credit card or checking account can use cash to purchase goods and services normally purchased with credit or check;

Buyers can limit the amount of their personal information they disclose by making cash instead of credit payments;

Buyers can make cash payments at financial institutions without having to open a deposit account;

Buyers can pay cash for goods and services purchased via media such as TV, radio, telephone, or internet;

Buyers can use cash to prepay for goods and services purchased via media such as TV, radio, telephone, or internet; and

Buyers can select a convenient location to make cash payments.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method to facilitate a cash payment between a seller and a buyer, the method comprising:
receiving data identifying a seller;
receiving data identifying a buyer;
receiving data identifying a financial institution, a party other than the buyer having a deposit account with the financial institution, that will accept the cash payment from the buyer and deposit the cash payment in the deposit account;
processing the data identifying the seller, the buyer, and the financial institution to generate information about the cash payment, the information including the identity of the seller, the buyer, and the financial institution; and
fixing the information in a tangible medium.

2. The method of claim 1 wherein the tangible medium is in a physical format.

3. The method of claim 2 wherein a magnetic medium embodies the information.

4. The method of claim 2 wherein a device capable of generating a radio frequency embodies the information.

5. The method of claim 2 wherein indicia embody the information.

6. The method of claim 5 wherein the indicia appear in an MICR format.

7. The method of claim 5 wherein the indicia are electronically readable.

8. The method of claim 5 wherein the indica are optically scanable.

9. The method of claim 5 wherein the indicia further include data identifying a product or service.

10. The method of claim 9 wherein the data identify a product and a product identification number.

11. The method of claim 9 wherein the data identify a service and a service identification number.

12. The method of claim 1 wherein the tangible medium is in an electronic format.

13. The method of claim 1 wherein the data identifying the seller include a financial institution associated with the seller.

14. A method to facilitate a cash payment between a seller and a buyer, the method comprising:
receiving information from a tangible medium, the information identifying a seller, a buyer, and a financial institution, a party other than the buyer having a deposit account with the financial institution, that will accept the cash payment from the buyer and deposit the cash payment in the deposit account;
processing the information to generate data about the cash payment, the data including the identity of the seller, the buyer, and the financial institution; and
transmitting a signal that contains the data about the cash payment.

15. The method of claim 14 wherein the tangible medium is in a physical format.

16. The method of claim 15 wherein a magnetic medium embodies the information.

17. The method of claim 15 wherein a device capable of generating a radio frequency embodies the information.

18. The method of claim 15 wherein indicia embody the information.

19. The method of claim 18 wherein the indicia appear in an MICR format.

20. The method of claim 18 wherein the indicia are electronically readable.

21. The method of claim 18 wherein the indica are optically scanable.

22. The method of claim 18 wherein the indicia further include data identifying a product or service.

23. The method of claim 22 wherein the data identify a product and a product identification number.

24. The method of claim 22 wherein the data identify a service and a service identification number.

25. The method of claim 14 wherein the tangible medium is in an electronic format.

26. The method of claim 14 wherein the data identifying the seller include a financial institution associated with the seller.

27. A method to facilitate a cash payment between a seller and a buyer, the method comprising:
receiving a signal that contains data derived from information fixed in a tangible medium, the information identifying a seller, a buyer, and a financial institution, a party other than the buyer having a deposit account with the financial institution, that accepted the cash payment from the buyer and deposited the cash payment in the deposit account;
processing the data from the signal; and
initiating a transfer of a monetary value from the deposit account based on the data contained in the signal.

28. The method of claim 27 wherein the tangible medium is in a physical format.

29. The method of claim 28 wherein a magnetic medium embodies the information.

30. The method of claim 28 wherein a device capable of generating a radio frequency embodies the information.

31. The method of claim 28 wherein indicia embody the information.

32. The method of claim 31 wherein the indicia appear in an MICR format.

33. The method of claim 31 wherein the indicia are electronically readable.

34. The method of claim 31 wherein the indica are optically scanable.

35. The method of claim 31 wherein the indicia further include data identifying a product or service.

36. The method of claim 35 wherein the data identify a product and a product identification number.

37. The method of claim 35 wherein the data identify a service and a service identification number.

38. The method of claim 27 wherein the tangible medium is in an electronic format.

39. The method of claim 27 wherein the data identifying the seller include a financial institution associated with the seller.
